(19) United States
(12) Patent Application Publication
(10) Pub. No.: US 2005/0250085 A1
(43) Pub. Date: Nov. 10, 2005

(54) Viewing and display apparatus

(75) Inventors: Michael Lemp III, Aliso Viejo, CA (US); Michael Hatalski, Aliso Viejo, CA (US)

Correspondence Address: CROCKETT & CROCKETT, 24012 CALLE DE LA PLATA, SUITE 400, LAGUNA HILLS, CA, 92653, US

(73) Assignee: Yamcon, Inc.

(21) Appl. No.: 10/841,215

(22) Filed: May 7, 2004

(51) Int. Cl. G09B 27/00; G09B 23/00; A63B 69/16

(52) U.S. Cl. 434/284; 434/289

(57) ABSTRACT

A celestial object location and identification device.

### FIELD OF THE INVENTIONS

The inventions described below relate the field of astronomy, specifically to an electronic device capable of locating and identifying celestial objects.

### BACKGROUND OF THE INVENTIONS

Norton, Viewing And Display Apparatus, U.S. Pat. No. 5,311,203 (May 10, 1994) describes a viewing device for identifying features of interest which appear in the field of view of the device. Though Norton was described in the context of a hand-held star-gazing device, and purported to provide information about asterisms (constellations or groups of stars) in the field of view, the device does not work unless held with certain components held perfectly vertical during use. Any twisting or rotation of the device about the viewing axis necessarily causes errors, and introduces ambiguity that cannot be resolved. Thus, it is not possible to implement the Norton system, as proposed by Norton, in a hand-held device. Norton consists of a box-like housing with a viewing channel therethrough, an LCD display and image overlay system for superimposing an image on the field of view, optics for manipulating the superimposed image to make it appear at infinity, a single axis eccentrically weighted inclinometer to measure inclination of the device and three magnetic sensors to determine the bearing of the device, a database with information regarding the constellations which might be viewed with the device, and a microprocessor. The viewing channel establishes a field of view for the user, through which the user can see constellations. The microprocessor is programmed to interpret sensor input and search the database for constellations in the field of view, and transmit a reference display data to the display.

The Norton system suffers from crippling defects. An operational device depends on perfect vertical alignment of the inclinometer. Without perfect vertical alignment of the inclinometer the device cannot unambiguously determine its orientation. The slightest deviation from vertical introduces ambiguity, such that the device can determine only that the viewing channel is aligned somewhere on a wide arc of the sky. If the device is not held perfectly vertically, that is, if it is twisted or rotated about the viewing axis, projection errors are introduced into the output from the inclinometer, so that the device has inadequate information regarding its inclination. In the case that the twist induced error is small enough that the device can determine its viewing axis with enough precision to generate a reference display that corresponds to constellations in the field of view, the device has no way to determine that it is twisted, and thus cannot rotate the reference display to align with the constellation.

The Norton system has a further limitation in regards to the viewing system employed. The Norton system discloses an approach utilizing a predetermined field of view using a beam combiner, mirrors and a lens so that the superimposed image is positioned at infinity and of the correct scale to align properly with the background of stars and celestial objects. There is an inherent problem with this approach, it does not allow for any deviation in the distance that the operator is holding the device between their eye and the device. For example, users with glasses will see a dramatically different field of view than users without. This is a problem with no disclosed or obvious solution proposed by Norton. As the Norton system requires a predetermined field of view, this means that the distance between the users eye and the device must be fixed. Any deviation will change the field of view and the superimposed image will not be of the proper scale to align with the background stars and celestial objects.

### SUMMARY

The devices and methods described below provide critical enablement and improvements for the Norton device. One improvement provides for gimballing of the inclinometer of Norton, to eliminate a source of large error inherent in normal use of the device. Another improvement provides for gimballing of an inclinometer or gravitational sensor, and a hunting gravitational sensor, to provide accurate direction sensing. Another improvement provides for use of accelerometer based sensor disposed parallel to the viewing axis of the device to minimize rotation error. Other improvements provide rotation sensing and for rotation and scaling of superimposed images to account for user rotation of the device and user-created variation in the field of view presented by the device to the eye.

### BRIEF DESCRIPTION OF THE DRAWINGS

FIG. 1 illustrates the viewing device of the prior art.

FIGS. 2 and 3 illustrate the source of error inherent in use of an inclinometer in a viewing device.

FIG. 4 illustrates a viewing device with a gimbaled inclinometer.

FIG. 5 illustrates a viewing device with an accelerometer-based gravity sensor oriented with its axis of maximum sensitivity aligned parallel to the sighting channel.

FIG. 6 illustrates rotation of superimposed image based on sensed rotation of viewing device.

FIG. 7 illustrates rotation of superimposed image based on sensed distance of viewing device from the user.

### DETAILED DESCRIPTION OF THE INVENTIONS

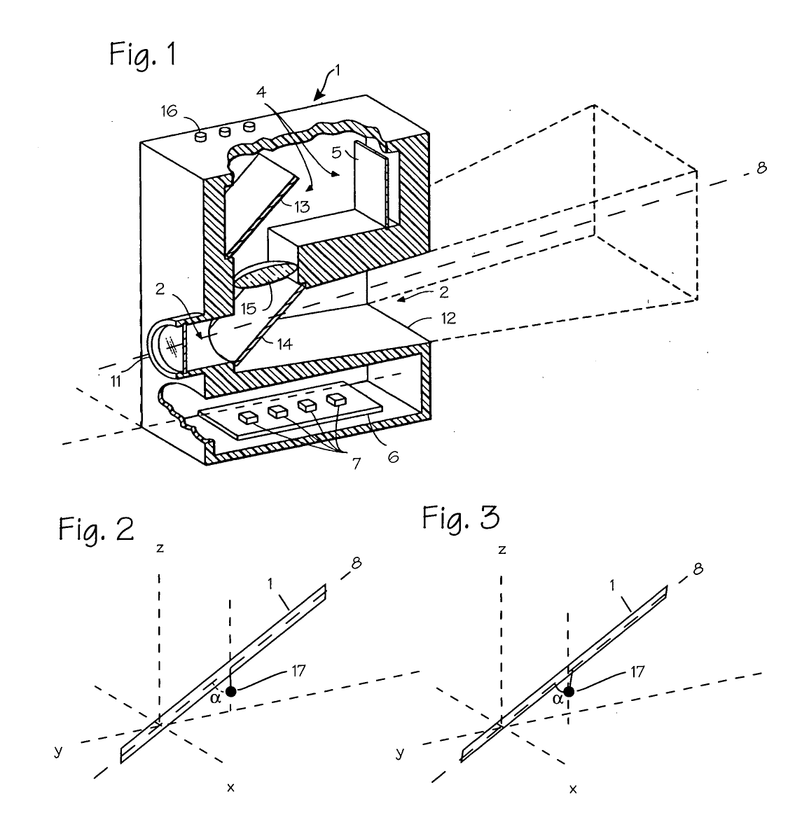

FIG. 1 illustrates the device proposed in Norton. The device includes the housing 1, an optical arrangement, indicated generally at 2, for defining the field of view 3 of the apparatus, an overlay arrangement 4, for overlaying or superimposing a reference display on that field of view, and LCD display 5 on which the reference display is generated, a printed circuit board 6, which includes the system electronics and a sensing mechanism, indicated diagrammatically at 7, for sensing the three-dimensional direction in which field of view 3 is aimed. The field of view is centered around the viewing axis 8. The “optical arrangement” comprises a view port 11 and a field stop 12 and other optics to force the reference display to appear at infinity. The overlay arrangement 4 comprises the LCD display 5, a re-directing mirror 13, an image combining mirror 14, and a focusing lens 15. Norton provides the lens 15 to modify the reference display presented to the user so that it appears at infinity (matching the viewed constellation). An interface consisting of a screen update button 16 is provided

As described by Norton, the direction-sensing mechanism 7 includes an potentiometer-type inclinometer for sensing the inclination of the line of sight of the instrument to the horizontal and three orthogonal magnetic sensors for sensing the orientation of the instrument with respect to the local magnetic field of the earth. This potentiometer-type inclinometer includes a potentiometer having an eccentrically weighted shaft for varying the potentiometer resistance. The shaft tends to seek a resting position with the eccentric weight on the bottom. The potentiometer is mounted with the shaft axis of rotation perpendicular to the instrument and lying in the horizontal plane. As the inclination of the instrument is changed, i.e., as the line of sight is raised or lowered, the shaft rotates under the pull of the eccentric weight and causes the resistance to vary and the voltage across the wiper of the potentiometer to vary commensurately. Thus, the voltage output of the potentiometer is proportional to, and provides a measure of, the inclination of the line of sight to the horizontal.

However, if the device is rotated even slightly about the viewing axis, the output of the potentiometer will not vary corresponding unambiguously to the inclination of the viewing axis. FIGS. 2 and 3 demonstrate this twist error which is inherent in the inclinometer. In FIG. 2, the housing 1 is shown, schematically, in perfectly vertical orientation. The z axis represents up and down, the x and y axes represent the horizontal plane (north, south, east and west). The potentiometer weight 17 falls to its lowest attainable point, and creates an angle α which directly corresponds to the inclination of the device. In FIG. 3, the housing 1 is twisted about the viewing axis 8 slightly. The potentiometer weight attains its lowest position, but since the potentiometer is tilted, the angle α is altered. In typical use, where it is unrealistic to assume that a user will maintain perfect verticality of the device, the potentiometer cannot provide unambiguous indication of the inclination of the viewing axis. Thus, the system will not be able to determine, with any reliability, where it is pointed, and it will not be possible to superimpose an appropriate reference display which corresponds to the constellation the user is actually looking at when the microprocessor uses the sensor input to determine the field of view and select appropriate reference data.

Our own patents, Lemp, Celestial Object Location Device, U.S. Pat. No. 6,366,212 (Apr. 2, 2002) and U.S. Pat. No. 6,570,506 (May 27, 2003) and our pending patent application Lemp, U.S. Publication 20030218546 (Nov. 27, 2003) (the entirety of which is hereby incorporated by reference) provides solutions to this problem. Lemp shows a device for viewing celestial objects from a location at a time and date ascertained by the device, comprising a viewing means to observe along a viewing axis defined by an azimuth angle and a nadir angle or altitude; a processor, a 3-axis magnetic sensor adapted to provide the processor with azimuth data representing the azimuth angle, a 3-axis gravitational sensor adapted to provide the processor with nadir data representing the nadir angle; location means for providing location data representing the location of the viewing device to the processor; time means for providing time and date data representing the time and date to the processor; and a database adapted to be accessed by the processor and provide data such that the processor determines celestial coordinates of right ascension and declination corresponding to the viewing axis based on the azimuth data, the nadir data, the location data, and the time and date data. The device can be used to direct a user to a celestial object (its resolution is very high, so that it can direct the user to individual stars and planets, as well as constellations and asterisms) and it can be used to identify an object to which the user has pointed the device.

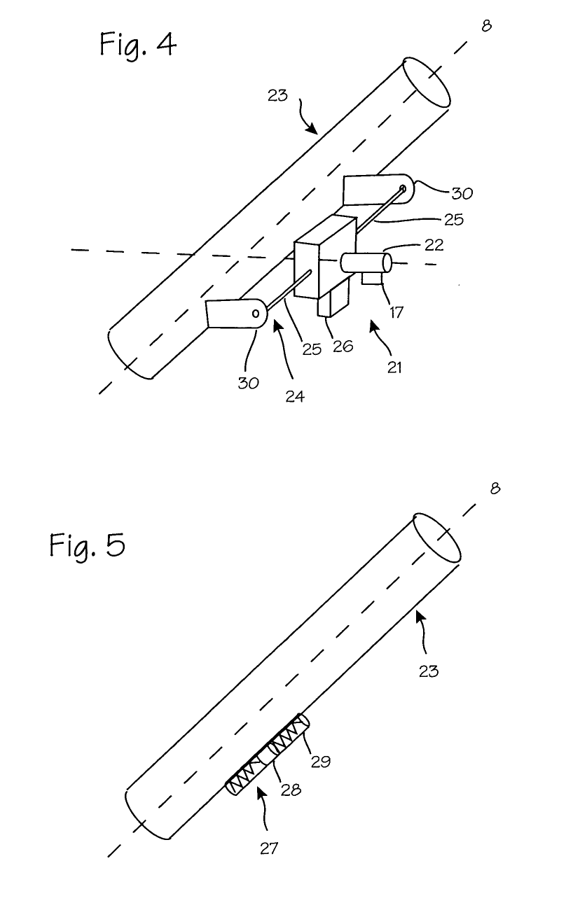

Additional solutions may be employed to limit, if not totally eliminate, the errors inherent in the Norton device. One solution is illustrated in FIG. 4, which illustrates a viewing device with a gimbaled inclinometer 21. The inclinometer shaft 22 is rotatably fixed to the housing of the device 23 through a gimbal mechanism 24 which allows the inclinometer weight to remain vertically oriented, regardless of the twist of the housing. The inclinometer 21 itself may be gimbaled to the housing, as shown, such that the entire inclinometer rotates about the gimbal shaft 25, under the pull of weight 26, to maintain its vertical orientation during twist, or the horizontal shaft of the inclinometer (which establishes the axis of rotation of the weighted shaft) may be rotatably fixed to its base, or the inclinometer weight 17 may be gimbaled to the horizontal shaft of the inclinometer. In each of these cases, the weighted shaft is free to fall in the vertical plane, and will therefore remain vertical. Accordingly, the angle between the eccentrically weighted shaft and the viewing axis will remain constant for a wide range of twist in the housing, and the inclinometer output will provide unambiguous indication of the actual inclination of the housing and viewing axis.

The device may be implemented also with a single-axis magnetic sensor in a gimbaled housing which rotates under control of a motor, with an encoder, potentiometer or other sensing means for sensing the angle between the sensor and the viewing axis, wherein the magnetic sensor output and direction of the sensor position relative to the housing are sampled by the microprocessor. The direction in which the magnetic sensor reading indicates maximum (or minimum, depending on the sensor electronics) will correspond to the local direction of magnetic north, and the angle corresponding to this point correlates to the azimuth angle. If in combination with this, a single-axis gravitational sensor is placed in a perpendicularly mounted gimbaled housing, and rotated as described earlier, then the altitude angle can be recovered. If a third sensor is used to read the angle that the gimbaled gravitational sensor rests relative to the housing, than the information required to determine altitude, azimuth and rotation are all present.

FIG. 5 illustrates a viewing device with an accelerometer-based gravity sensor oriented with its axis of maximum sensitivity aligned parallel to the sighting channel. This eliminates a rotation-induced error. As shown in FIG. 5, a gravity sensor 27 comprising a weight 28 longitudinally movable within a housing 29 has an axis of maximum sensitivity corresponding to the axis of movement of the weight. The sensor is fixed in relation to the viewing device with this axis of maximum sensitivity parallel to the viewing axis. Rotation of the viewing channel will not result in projection errors. If instead, the sensor axis were perpendicular to the viewing axis, and initially vertically oriented, inclination could be sensed, but rotation errors would be high, and if the sensor axis were perpendicular to the viewing axis, and initially horizontally oriented, it would remain horizontal during inclination, and provide no input.

Regarding the database structure proposed by Norton, the system can be greatly improved with the use of a two dimensional data set rather than a three dimensional data set. The preferred two-dimensional data set correlate Right Ascension and Declination with celestial objects and reference data regarding the celestial objects. This is only possible after a translation of the terrestrial coordinates to celestial coordinates which require time/date and location information. However, after this translation is done, there are several benefits. First the size of the database would be smaller, thus reducing memory requirements and cost. Also, because the searching algorithm would need to perform the search on reduced set of criteria, the searches may be accomplished more quickly, and require a lower processing power CPU, thereby reducing the cost further.

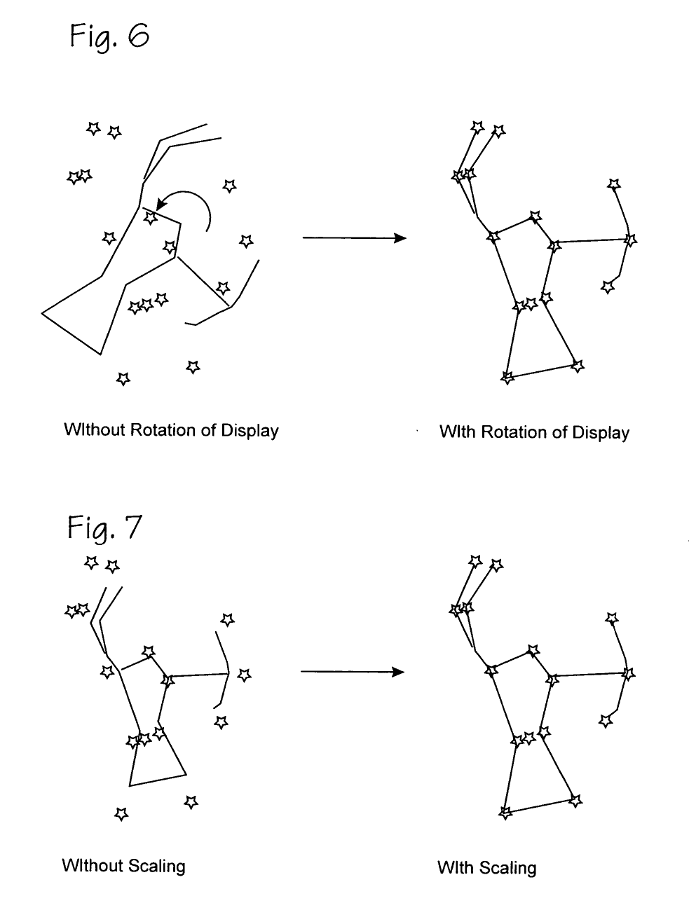

With the improvements disclosed above, a Norton-type device can be enabled to provide reference data which corresponds to viewed constellations. If, however, it is desired to superimpose reference data including constellation outlines over a constellation in the field of view, Norton must be further improved because it cannot sense rotation of the device about the viewing axis, and thus cannot determine the appropriate orientation of the constellation outline. If it is intended to present text data, the text data will appear at an angle as well. With the addition of gravitational sensors sensing gravity on a plurality of axes (two or three axes) as disclosed in Lemp, the rotation of the device about the viewing axis can be unambiguously determined. Also, a potentiometer, encoder, or other angle sensing means may be operably connected between the inclinometer and the gimbal mount 30 or gimbal shaft 25 shown in FIG. 4 to sense the rotation of the inclinometer, the output of this angle sensing means may in turn be used by the microprocessor to determine the degree of twist of the housing. Thus, the microprocessor may use input from the sensor, including the 3-axis magnetic field sensors and the 3-axis gravitational sensor of Lemp (or the gimbaled inclinometer of FIG. 4 in combination with the 3-axis magnetic sensors)) to determine the rotation of the device, and provide display data to the LCD display such that the reference display is rotated as appropriate to align with a preferred orientation, which in the case of a viewed constellation would be the orientation of the constellation, and in the case of text data would be horizontally aligned text. The effect of this rotation is shown in FIG. 6, which shows the well-known constellation Orion with a reference display over the constellation in incorrect orientation, as would be expected if the device does not correct for twist. The constellation itself is difficult for novice observers to pick out from the sky, and correlating the improperly aligned outline with the appropriate stars is quite difficult. Upon rotation, even novice observers can see the constellation, as is apparent from the illustration.

With further improvements, the dependence of the Norton device on a fixed distance between the user's eye and the ocular lens of the device may be eliminated. Norton provides a device with a predetermined field of view. However, the field of view presented to the eye by any scope changes drastically as the scope is moved away from the eye by mere millimeters. Thus, users wearing eyeglasses (or for other reasons, preferring to hold the device far away from the eye) will experience a different field of view compared to users without eyeglasses. Accordingly, the superimposed image may not be properly scaled to correspond to a constellation viewed by the user, as shown in FIG. 7. To account for this, an eye tracker providing output can be placed on the ocular end (the proximal end, relative to the user) of the device, on or near the eyepiece, and operated to sense the distance from the device to the users eyes. The microprocessor is additionally programmed to receive eyepiece-to-eye distance information from the eye tracker and adjust the reference display accordingly. The superimposed image may then be scaled appropriately, either through software scaling of the display fed to the LCD or by zooming optics between the LCD and the user. The result of this operation is shown in FIG. 7, where the outline of the constellation Orion, when improperly scaled, is quite difficult to associate with the stars of the constellation, but the system has scaled the outline to account to user distance from the eyepiece. The additional ability of the eye tracker system to determine the direction of the user's eye may also be used to determine what particular star or planet within the field of view the user is particularly focused on, and provide particularly corresponding data on that object.

The scaling effect illustrated in FIG. 7 may also be employed when the device is implemented in telescopes and binoculars, especially those with variable magnification, such that the superimposed image or reference data may be scaled as appropriate for the magnification by the optics of the device. Again, the microprocessor can use input from the sensors, such as sensors adapted to provide information regarding the optics employed, to adjust the display data provided to the LCD display, or manipulate optics between the viewer and the LCD display, to provide appropriate scaling.

The various aspects of the inventions may be implemented with various types of sensors. The magnetic field sensors may include induction sensors, fluxgate sensors, magneto resistors, Hall effect sensors, magneto-optical sensors, resonance magnetometers, SQUIDS (superconducting quantum interference devices) and others. Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A apparatus for use in viewing a predetermined subject and presenting information to the user about features of the subject visible in the field of view, comprising:
a housing, said housing containing:
viewing means defining the field of view and a viewing axis;
direction sensing means for sensing a characteristic three-dimensional direction of said field of view, said direction sensing means comprising a 3-axis magnetic sensor and an inclinometer;
a database containing data about the predetermined subject, the data being arranged in said database to be correlated with three-dimensional directions;
output means for providing data from said database to a user,
microprocessor means responsive to said direction sensing mechanism and coupled to said database and to said output means to provide data about the subject to the user, the provided data being correlated with three-dimensional directions falling within said field of view of predetermined size;
wherein the inclinometer is rotatably fixed in relation to the housing.

2. A apparatus for use in viewing a predetermined subject and presenting information to the user about features of the subject visible in the field of view, comprising:
a housing, said housing containing:
viewing means defining the field of view and a viewing axis;
a single axis magnetic sensor rotatably fixed to the housing, and a motor operable to rotate the magnetic sensor, and means for sensing the angle between the sensor and the viewing axis;
a single axis inclinometer or gravitational sensor rotatably fixed to the housing,
a database containing data about the predetermined subject, the data being arranged in said database to be correlated with three-dimensional directions;
output means for providing data from said database to a user,
microprocessor means responsive to the magnetic sensor and the inclinometer or gravitational sensor, and operable to determine the viewing axis, and coupled to the database and to the output means to provide data about the subject to the user, the provided data being correlated with the viewing axis.

3. The device of claim 2, further comprising means for sensing the angle between the inclinometer or gravitational sensor and the viewing axis.

4. A apparatus for use in viewing a predetermined subject and presenting information to the user about features of the subject visible in the field of view, comprising:
a housing, said housing containing:
viewing means defining said field of view and a viewing axis;
direction sensing means for sensing a characteristic three-dimensional direction of said field of view, said direction sensing means comprising a 3 axis magnetic sensor and single axis gravity sensor;
a database containing data about the predetermined subject, the data being arranged in said database to be correlated with three-dimensional directions;
output means for providing data from said database to a user,
microprocessor means responsive to said direction sensing mechanism and coupled to said database and to said output means to provide data about the subject to the user, the provided data being correlated with three-dimensional directions falling within said field of view of predetermined size;
wherein the single axis gravity sensor has an axis of maximum sensitivity and is fixed in relation to the housing such that the axis of maximum sensitivity is parallel to the viewing axis.
